(19) United States
(12) Patent Application Publication
(10) Pub. No.: US 2007/0211334 A1
(43) Pub. Date: Sep. 13, 2007

(54) POLARIZER PROTECTIVE FILM, POLARIZING PLATE AND IMAGE DISPLAY

(75) Inventors: Naoki Tsujiuchi, Osaka (JP); Akihiro Nishida, Osaka (JP); Kenji Yoda, Osaka (JP); Keigo Ehara, Yamaguchi (JP); Hiroshi Kurisu, Yamaguchi (JP); Yoshiki Takesue, Yamaguchi (JP); Norimasa Maida, Yamaguchi (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignees: NITTO DENKO CORPORATION, OSAKA JAPAN (JP); TOYO KOHAN CO., LTD., TOKYO JAPAN (JP)

(21) Appl. No.: 11/568,876

(22) PCT Filed: Apr. 28, 2002
(86) PCT No.: PCT/JP05/08192

§ 371 Date: Nov. 9, 2006

(51) Int. Cl. G02B 5/30; C08K 5/01

(52) U.S. Cl. 359/483; 524/849

(57) ABSTRACT

A polarizer protective film of the present invention comprises a thermoplastic resin layer having a moisture permeability of 100 g/m²/24 hours or less; and a resin layer that comprises a copolymer containing a styrene monomer unit and is laminated on the thermoplastic resin layer through an adhesive resin layer. The polarizer protective film can have good adhesion to a polarizer when it is bonded to the polarizer through an adhesive layer to form a polarizing plate, and can form a polarizing plate with good polarization properties.

### TECHNICAL FIELD

The invention relates to a polarizer protective film and a polarizing plate using the same. The polarizing plate itself or an optical film in which the polarizing plate is laminated can be used to form a liquid crystal display, an organic electro-luminescent display, a plasma display panel, or the like.

### BACKGROUND ART

The image-forming system of liquid crystal displays or the like requires polarizing plates to be placed on both sides with respect to a glass substrate that forms the surface of a liquid crystal panel. Such polarizing plates being used generally include: a polarizer made of a polyvinyl alcohol based film and a dichroic material such as iodine; and protective films that use triacetylcellulose or the like and are bonded to both sides of the polarizer with a polyvinyl alcohol based adhesive.

However, triacetylcellulose does not have sufficient resistance to moisture or heat, and thus the polarizing plate using a triacetylcellulose film as a protective film has the disadvantage that the performance of it such as degree of polarization and hue can be reduced if it is used at high temperatures or high humidity. In addition, the triacetylcellulose film causes a retardation with respect to incident light in oblique directions. Such a retardation significantly affects viewing angle properties as liquid crystal displays have been increased in size in recent years.

In order to solve the above problem, it is proposed that cyclic olefin based resins be used as the material for protective films in place of the triacetylcellulose. Cyclic olefin based resins have low moisture permeability and almost no retardation in oblique directions. However, polyvinyl alcohol based adhesives provide poor adhesion between a cyclic olefin based resin film and a polyvinyl alcohol based polarizer, while they provide good adhesion between a triacetylcellulose film and a polyvinyl alcohol based polarizer.

Thus, there is proposed a method of bonding a cyclic olefin based resin film to a polyvinyl alcohol based polarizer through an acrylic pressure-sensitive adhesive layer (see Japanese Patent Application Laid-Open (JP-A) No. 05-212828). However, this method requires heating and pressing for bonding and has a long heating time and thus has a problem in which the polyvinyl alcohol based polarizer can be discolored and the degree of polarization of the polarizing plate can be significantly reduced. Because of the need for long time heating, this method also has a problem in which the production efficiency is relatively low and the film can be deformed.

There is also proposed a protective film having a layer made of a polymer comprising a styrene based monomer, a vinylester based monomer, a maleic anhydride based monomer and an acrylate ester based or a methacrylate ester monomer, or the like (see JP-A No. 09-197128 and JP-A No. 09-281333). It is also proposed that the protective film further include a polyvinyl alcohol based resin layer laminated on the side of the layer made of the polymer or the like. There is also disclosed a polarizing plate having a polyvinyl alcohol based polarizer bonded to the polyvinyl alcohol based resin layer. However, this technique has a problem in which a separated or striped portion can be generated when the protective film and the polyvinyl alcohol based polarizer are bonded together so that the appearance can be unstable, the polarization properties can be insufficient, and the productivity can be poor.

There is also proposed a protective film including a thermoplastic saturated norbornene film, a polyurethane resin layer and a polyvinyl alcohol based resin layer (see JP-A No. 2001-174637). There is also disclosed a polarizing plate having a polyvinyl alcohol based polarizer bonded to the polyvinyl alcohol based resin layer. However, this technique also has a problem in which a separated or striped portion can be formed when the protective film and the polyvinyl alcohol based polarizer are bonded together so that the appearance can be unstable, the polarization properties can be insufficient, and the productivity can be poor.

### DISCLOSURE OF INVENTION

### Problems to be solved by the Invention

It is an object of the invention to provide a polarizer protective film that includes a thermoplastic resin with a moisture permeability of 100 g/m²/24 hours or less, can have good adhesion to a polarizer when it is bonded to the polarizer through an adhesive layer to form a polarizing plate, and can form a polarizing plate with good polarization properties.

It is another object of the invention to provide a polarizing plate having a polarizer bonded to the polarizer protective film through an adhesive layer and to provide an image display using the polarizing plate.

Means for Solving the Problems

As a result of active investigations for solving the above problems, the inventors have found that the above objects can be achieved with the polarizer protective film as described below and have completed the invention.

The present invention is related to a polarizer protective film, comprising:

a thermoplastic resin layer having a moisture permeability of 100 g/m²/24 hours or less; and

a resin layer that comprises a copolymer containing a styrene monomer unit and is laminated on the thermoplastic resin layer through an adhesive resin layer.

The protective film of the invention includes a thermoplastic resin with a moisture permeability of 100 g/m²/24 hours or less. The protective film including a thermoplastic resin with a moisture permeability of 100 g/m²/24 hours or less can form a polarizing plate that has good durability at high temperatures or high humidity and has good resistance to moisture and heat. Since the protective film also includes the copolymer resin layer in the side to be bonded to a polarizer, the polarizer and the protective film can be strongly bonded together even in the case where the protective film material is a thermoplastic resin with a moisture permeability of 100 g/m²/24 hours or less. Additionally, there is no separated or striped portion found in the resulting polarizing plate, and the polarizing plate has a good appearance and good polarization properties. Since polarizing plates with a good appearance can be stably produced as described above, high productivity can be achieved.

The protective film has the copolymer resin layer laminated on the thermoplastic resin layer through an adhesive resin layer. In the case where an adhesive resin layer is provided between the thermoplastic resin layer and the copolymer resin layer, the adhesion between the thermoplastic resin layer and the copolymer resin layer can be increased.

In the polarizer protective film, the copolymer containing a styrene monomer unit is preferably a copolymer containing a styrene monomer unit and an olefin monomer unit.

The thermoplastic resin used as the protective film is preferably a cyclic olefin based resin. A cyclic olefin based resin has specially a good resistance to moisture and heat.

In the protective film, the adhesive resin layer that made of a polyolefin resin modified with an unsaturated carboxylic acid or a derivative thereof is suitable to use. In the case where the adhesive resin layer is made of a polyolefin resin modified with an unsaturated carboxylic acid or a derivative thereof, there can be provided a protective film having the thermoplastic resin layer and the copolymer resin layer particularly strongly bonded together.

The protective film is preferably produced by co-extruding the resins for forming the respective layers. By the co-extrusion, a protective film with good adhesion between the layers can be produced with high productivity.

The copolymer resin layer side surface of the protective film is preferably corona-treated. The corona treatment can activate the surface of the resin layer so that the adhesion between the adhesion layer and the protective film can be increased when the resin layer is bonded to the polarizer.

The present invention is also related to a polarizing plate, comprising:

a polarizer; and

the above polarizer protective film, wherein

the copolymer resin layer side of the polarizer protective film is laminated on at least one side of the polarizer through an adhesion layer.

The polarizing plate is suitable to use the adhesion layer that is made of a polyvinyl alcohol based adhesive.

The polarizing plate is suitable to the polarizer that is a polyvinyl alcohol based polarizer.

The present invention is also related to an image display, comprising the above polarizing plate.

### BRIEF DESCRIPTION OF DRAWING

FIG. 1 is an example of a polarizing plate of this invention;

FIG. 2 is an example of a polarizing plate of this invention;

FIG. 3 is an example of a polarizing plate of this invention;

### BEST MODE FOR CARRYING OUT THE INVENTION

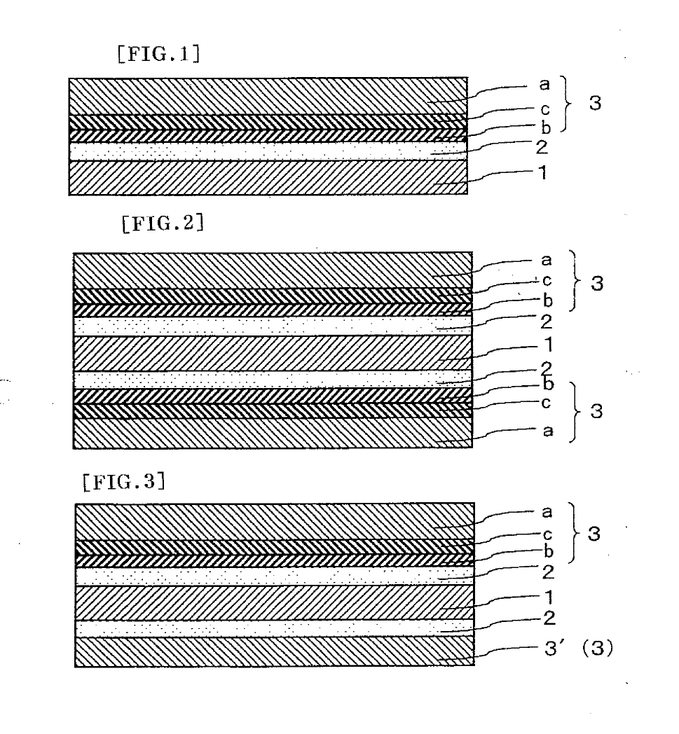

FIGS. 1 to 3 each show a polarizing plate that includes a polarizer 1 and a polarizer protective film 3 according to the invention, which is provided on at least one side of the polarizer 1 through an adhesion layer 2 made of an adhesive and comprises a laminate including a thermoplastic resin layer (a) with a moisture permeability of 100 g/m²/24 hours or less and a resin layer (b) that comprises a copolymer containing a styrene monomer unit and is laminated on the thermoplastic resin layer (a) through an adhesive resin layer(c). The protective film 3 includes a copolymer resin layer (b) in the polarizer 1 side. The protective film 3 may only be provided on at least one side of the polarizer 1. FIG. 1 each shows an example where the protective film 3 is provided on only one side of the polarizer 1. One or both of the protective films 3 provided on both sides of the polarizer 1 may or may not include the adhesive resin layer (c), while they each include the thermoplastic resin layer (a) and the copolymer resin layer (b). FIG. 2 shows an example where the protective films 3 each including the adhesive resin layer (c) are provided on both sides of the polarizer 1. FIG. 3 shows an example where the protective film 3 is provided on one side of the polarizer 1 and the protective film 3 or any protective film 3′ other than the protective film 3 is provided on the other side of the polarizer 1 through an adhesion layer 2.

A polarizer 1 is not limited especially but various kinds of polarizer may be used. As a polarizer, for example, a film that is uniaxially stretched after having dichromatic substances, such as iodine and dichromatic dye, absorbed to hydrophilic high molecular weight polymer films, such as polyvinyl alcohol based film, partially formalized polyvinyl alcohol based film, and ethylene-vinyl acetate copolymer based partially saponified film; poly-ene based orientation films, such as dehydrated polyvinyl alcohol and dehydrochlorinated polyvinyl chloride, etc. may be mentioned. In these, a polyvinyl alcohol based film comprises dichromatic materials such as iodine is suitably used. Although thickness of polarizer is not especially limited, the thickness of about 5 to 80 μm is commonly adopted.

A polarizer that is uniaxially stretched after a polyvinyl alcohol based film dyed with iodine is obtained by stretching a polyvinyl alcohol film by 3 to 7 times the original length, after dipped and dyed in aqueous solution of iodine. If needed the film may also be dipped in aqueous solutions, such as boric acid and potassium iodide, which may include zinc sulfate, zinc chloride. Furthermore, before dyeing, the polyvinyl alcohol based film may be dipped in water and rinsed if needed. By rinsing polyvinyl alcohol based film with water, effect of preventing un-uniformity, such as unevenness of dyeing, is expected by making polyvinyl alcohol based film swelled in addition that also soils and blocking inhibitors on the polyvinyl alcohol based film surface may be washed off. Stretching may be applied after dyed with iodine or may be applied concurrently, or conversely dyeing with iodine may be applied after stretching. Stretching is applicable in aqueous solutions, such as boric acid and potassium iodide, and in water bath. The stretching method is not limited; a wet method or a dry method may be adopted.

Examples of the thermoplastic resin for use in forming the thermoplastic resin layer (a) of the protective film 3 include polycarbonate based polymers; arylate based polymers; polyester based polymers such as polyethylene terephthalate and polyethylene naphthalate; amide based polymers such as nylon and aromatic polyamides; polyolefin based polymers such as polyethylene, polypropylene and ethylene-propylene copolymers; cyclic olefin based resins having a cyclo-system or a norbornene structure; and any mixtures thereof.

Moreover, as is described in Japanese Patent Laid-Open Publication No. 2001-343529 (WO 01/37007), polymer films, for example, resin compositions including (A) thermoplastic resins having substituted and/or non-substituted imido group in sidechain, and (B) thermoplastic resins having substituted and/or non-substituted phenyl and nitrile group in sidechain may be mentioned. As an illustrative example, a film may be mentioned that is made of a resin composition including alternating copolymer comprising iso-butylene and N-methyl maleimide, and acrylonitrile-styrene copolymer. A film comprising mixture extruded article of resin compositions etc. may be used.

The cyclic olefin based resins are particularly preferred among the materials for the thermoplastic resin (a). The cyclic olefin based resin is a generic name and specifically described in JP-A No. 03-14882 and JP-A No. 03-122137. Specific examples thereof include ring-opened polymers of cyclic olefins, addition polymers of cyclic olefins, random copolymers of cyclic olefins and α-olefins such as ethylene and propylene, and graft modifications thereof, which are modified with an unsaturated carboxylic acid, a derivative thereof or the like. Specific examples thereof also include hydrides thereof. Examples of the cyclic olefin include, but are not limited to, norbornene, tetracyclododecen, and derivatives thereof. Commercially available examples of the cyclic olefin based resin include ZEONEX and ZEONOR manufactured by Nippon Zeon Co., Ltd., ARTON manufactured by JSR Corporation, and Topas manufactured by TICONA Company.

The thickness of the thermoplastic resin layer (a) is generally at most 500 μm, preferably from 1 to 300 μm, particularly preferably from 5 to 200 μm. The thermoplastic resin layer has a moisture permeability of 100 g/m₂/24 hours or less. A moisture permeability of more than 100 g/m²/24 hours can cause a significant change in the size of the thermoplastic resin layer (a) and thus is impractical.

In order to increase the adhesion to the polarizer 1, the copolymer resin layer (b) that includes a copolymer containing a styrene monomer unit, preferably containing a styrene monomer unit and an olefin monomer unit, is provided in the side of the protective film 3 to be bonded to the polarizer 1. For example, the copolymer resin layer (b) may be made of a block copolymer having an aromatic vinyl compound polymer block and a conjugated diene compound polymer block and/or a hydrogenated product of the block copolymer. The block copolymer has a styrene polymer block and a conjugated diene, such as isoprene and butadiene, polymer block or a hydrogenated product thereof.

Examples of the block copolymer include styrene-diene AB-type block copolymers (diblock copolymers) such as styrene-butadiene (SB) copolymers and styrene-isoprene (SI) copolymers; styrene ABA-type block copolymers (triblock copolymers) such as styrene-butadiene-styrene (SBS) copolymers and styrene-isoprene-styrene (SIS) copolymers; styrene ABAB-type block copolymers (tetrablock copolymers) such as styrene-butadiene-styrene-butadiene (SBSB) copolymers and styrene-isoprene-styrene-isoprene (SISI) copolymers; styrene ABABA-type block copolymers (pentablock copolymers) such as styrene-butadiene-styrene-butadiene-styrene (SBSBS) copolymers and styrene-isoprene-styrene-isoprene-styrene (SISIS) copolymers; and styrene-diene multiblock copolymers having more AB repeating units. Commercially available examples of the block copolymer include Clear Resin series manufactured by Denki Kagaku Kogyo Kabushiki Kaisha.

The block copolymer to be used is preferably a hydrogenated product in which an ethylenic double bond is hydrogenated. Examples thereof include styrene/ethylene-butylene copolymers (SEB), styrene/ethylene-propylene copolymers (SEP), styrene/ethylene-butylene copolymer/styrene (SEBS), styrene/ethylene-propylene copolymer/styrene (SEPS), and styrene/ethylene-butylene copolymer/styrene/ethylene-butylene copolymer (SEBSEB). Commercially available examples of the hydrogenated product of the block copolymer include Tuftec H series manufactured by Asahi Kasei Corporation, KRATON G series manufactured by Shell Chemical Co., Ltd. and SEPTON series manufactured by Kuraray Co., Ltd.

The block copolymer and/or the hydrogenated product thereof to be used may also have a functional group (a). Examples of the functional group (a) include a carboxyl group and derivatives thereof. For example, the carboxyl group or the like may be introduced by adding maleic acid or the like. Commercially available examples of the hydrogenated product of the block copolymer having a carboxyl group or a derivative thereof include Tuftec M series manufactured by Asahi Kasei Corporation and KRATON FG1901X manufactured by Shell Chemical Co., Ltd. The functional group (a) may also be an epoxy group. The epoxy group may be introduced by graft polymerization of glycidyl (meth)acrylate.

The dry thickness of the copolymer resin layer (b) is preferably from 0.01 to 50 μm, more preferably from 0.1 to 10 μm, in terms of keeping the adhesion to the polarizer 1 and the thickness of the protective film 3 well.

The adhesion layer 2 side of the copolymer resin layer (b) may be subjected to dry treatment such as plasma treatment and corona treatment. The dry treatment may be performed using any known technique. In particular, the dry treatment is preferably corona treatment.

The adhesive resin layer (c) is preferably provided between the thermoplastic resin layer (a) and the copolymer resin layer (b). In a preferred mode, the adhesive resin layer (c) well adheres to both of the thermoplastic resin layer (a) and the copolymer resin layer (b). Examples of the resin for use in forming the adhesive resin layer (c) include low crystallinity flexible copolymers such as unsaturated polyolefins and polyolefin resins preferably modified with an unsaturated carboxylic acid or a derivative thereof; amorphous flexible copolymers such as unsaturated polyolefins; ethylene-acrylate ester-maleic anhydride terpolymers; and an adhesive resin composition containing any of these materials.

A detailed description is given below of the polyolefin resin modified with an unsaturated carboxylic acid or a derivative thereof, which is preferably used as the adhesive resin.

Examples of the olefin for use in producing the polyolefin resin modified with an unsaturated carboxylic acid or a derivative thereof include ethylene, propylene, 1-butene, 1-hexene, 4-methyl-1-pentene, 1-octene, 1-decene, 1-tetradecene, and 1-octadecene. In the invention, one or more of these olefins may be used alone or in any combination. The unsaturated carboxylic acid may be acrylic acid, maleic acid, fumaric acid, tetrahydrophthalic acid, itaconic acid, citraconic acid, isocrotonic acid, nadic acid, or the like, and the derivative thereof may be malenyl chloride, maleimide, maleic anhydride, citraconic anhydride, monomethyl maleate, glycidyl maleate, or the like. Among these materials, unsaturated dicarboxylic acids or acid anhydrides thereof are preferred, and maleic acid, nadic acid, or an acid anhydride thereof is particularly preferred.

Examples of commercially available resins for forming the adhesive resin layer (c) include maleic anhydride-modified polyolefin resins such as ADMER (trade name) manufactured by Mitsui Chemicals, Inc. and MODIC (trade name) manufactured by Mitsubishi Chemical Co., Ltd. and ethylene-acrylate ester-maleic anhydride terpolymers such as BONDINE (trade name) manufactured by Sumitomo Mitsui Polyolefin Co., Ltd.

The dry thickness of the adhesive resin layer (c) is preferably from 0.01 to 50 μm, more preferably from 0.1 to 10 μm, in terms of keeping the adhesion to the thermoplastic resin layer (a) and the copolymer resin layer (b) well and keeping the thickness of the protective film 3 well.

A coupling agent such as a silane coupling agent and a titanium coupling agent and a catalyst for allowing the coupling agent to react efficiently, such as a titanium-based catalyst and a tin-based catalyst, may be added to the resin for forming the copolymer resin layer (b) or the adhesive resin layer (c). Such additives can further increase the adhesive strength between the polarizer 1 and the protective film 3. Any other additive may also be added to the copolymer resin layer (b) or the adhesive resin layer (c). Specifically, a tackifier such as a terpene resin, a phenol resin, a terpene-phenol resin, a rosin resin, and a xylene resin, an ultraviolet absorbing agent, an antioxidant, and a stabilizing agent such as a heat-resistant stabilizer, or the like may also be used.

Any method may be used to produce the protective film 3 by laminating the copolymer resin layer (b) and optionally the adhesive resin layer (c) on the thermoplastic resin layer (a). Examples of such a method include, but are not limited to, a method including simultaneously or sequentially forming the thermoplastic resin layer (a) and the copolymer resin layer (b) and optionally the adhesive resin layer (c) by extrusion, a method including applying a resin solution to the thermoplastic resin layer (a) by a known technique and drying the resin solution, or a melt coating method. Co-extrusion in which the thermoplastic resin layer (a) and the copolymer resin layer (b) and optionally the adhesive resin layer (c) are simultaneously formed is preferred because of good productivity and good adhesion of the layers.

The co-extrusion method has good productivity, because it does not require a drying process for removing a solvent such as a process for removing an organic solvent from an adhesive by drying and vaporization, which would otherwise be used to remove a solvent from an adhesive in a dry lamination process. Specifically, the co-extrusion method may include the steps of supplying the thermoplastic resin to an extruder, supplying the copolymer resin to another extruder, wherein the two extruders are connected to a T-shaped die, melting and kneading each resin, then extruding the resins, respectively, and taking and water-cooling the extruded materials to form a laminated film. A further extruder may also be used, to which the adhesive resin may be supplied so that the adhesive resin can be co-extruded between the thermoplastic resin layer and the copolymer resin layer to form an adhesion layer-containing laminated film. The screw based of the extruder for use in melting the resin for each layer may be uniaxial or biaxial. An additive such as an antioxidant or a plasticizer optimal for each resin may also be added to each resin.

Examples of the material for the protective film 3′ other than the protective film 3 include cellulose based polymers such as diacetylcellulose and triacetylcellulose; acrylic based polymers such as poly(methyl methacrylate); and styrene based polymers such as polystyrene and acrylonitrile-styrene copolymers (AS resins). Examples of the polymer for forming the protective film also include sulfone based polymers, polyethersulfone based polymers, polyetheretherketone based polymers, polyphenylenesulfide based polymers, vinyl alcohol based polymers, vinylidene chloride based polymers, vinyl butyral based polymers, polyoxymethylene based polymers, epoxy based polymers, and any blends thereof. A thermosetting or ultraviolet-curable resin such as an acrylic, urethane, acrylic-urethane, epoxy, or silicone based resin may also be formed into a film for use as the protective film.

The thickness of the protective film 3′ is generally at most 500 μm, preferably from 1 to 300 μm, particularly preferably from 5 to 200 μm.

A hard coat layer or antireflection processing, processing aiming at sticking prevention, diffusion or anti glare may be performed onto the face, which is a face the copolymer resin layer (b) is not provided in the protective film 3, on which the polarizer of the above transparent protective film 3, 3′ has not been adhered.

A hard coat processing is applied for the purpose of protecting the surface of the polarizing plate from damage, and this hard coat film may be formed by a method in which, for example, a curable coated film with excellent hardness, slide property etc. is added on the surface of the protective film using suitable ultraviolet curable based resins, such as acrylic based and silicone based resins. Antireflection processing is applied for the purpose of antireflection of outdoor daylight on the surface of a polarizing plate and it may be prepared by forming an antireflection film according to the conventional method etc. Besides, a sticking prevention processing is applied for the purpose of adherence prevention with adjoining layer.

In addition, an anti glare processing is applied in order to prevent a disadvantage that outdoor daylight reflects on the surface of a polarizing plate to disturb visual recognition of transmitting light through the polarizing plate, and the processing may be applied, for example, by giving a fine concavo-convex structure to a surface of the protective film using, for example, a suitable method, such as rough surfacing treatment method by sandblasting or embossing and a method of combining transparent fine particle. As a fine particle combined in order to form a fine concavo-convex structure on the above surface, transparent fine particles whose average particle size is 0.5 to 20 μm, for example, such as inorganic type fine particles that may have conductivity comprising silica, alumina, titania, zirconia, tin oxides, indium oxides, cadmium oxides, antimony oxides, etc., and organic type fine particles comprising cross-linked or non-cross-linked polymers may be used. When forming fine concavo-convex structure on the surface, the amount of fine particle used is usually about 2 to 70 weight parts to the transparent resin 100 weight parts that forms the fine concavo-convex structure on the surface, and preferably 5 to 50 weight parts. An anti glare layer may serve as a diffusion layer (viewing angle expanding function etc.) for diffusing transmitting light through the polarizing plate and expanding a viewing angle etc.

In addition, the above antireflection layer, sticking prevention layer, diffusion layer, anti glare layer, etc. may be built in the protective film itself, and also they may be prepared as an optical layer different from the protective film.

The copolymer resin layer (b) of the protective film 3 and the polarizer 1 are bonded together using the adhesive layer 2. While the adhesive may be of any based such as solvent-based, water-based and hot melt based as long as it is optically transparent, a water-based adhesive is preferred. Examples of the adhesive may include polyvinyl alcohol based adhesives, gelatin based adhesives, vinyl based adhesives, latex based adhesives, polyurethane based adhesives, isocyanate based adhesives, polyester based adhesives, and epoxy based adhesives. The adhesive may contain any of various crosslinking agents. The adhesive may also contain any of catalysts, coupling agents, various tackifiers, ultraviolet absorbing agents, antioxidants, and stabilizing agents such as heat-resistant stabilizers, and hydrolysis-resistant stabilizers. The adhesive is generally used with a solids content of 0.1 to 20% by weight.

Among the adhesives, the polyvinyl alcohol based adhesive is preferred. The polyvinyl alcohol based adhesive may contain a polyvinyl alcohol based resin and a crosslinking agent.

Examples of polyvinyl alcohol based resin include: a polyvinyl alcohol obtained by saponifying a polyvinyl acetate; a derivative thereof; a saponified copolymer of vinyl acetate and a monomer copolymerizable therewith; and polyvinyl alcohols modified by acetalization, urethanization, etherification, grafting, phosphate esterification and the like. Examples of the monomers include, unsaturated carboxylic acids such as maleic anhydride, fumaric acid, crotonic acid, itaconic acid and (meth) acrylic acid, and esters thereof; α-olefins such as ethylene and propylene; (meth)allylsulfonic acid or sodium salt thereof, (meth)allylsulfonate; sodium sulfonate (monoalkyl maleate), sodium disulfonate (alkyl maleate); N-methylolacrylamide; an alkai salt of acrylamide alkylsulfonate; N-vinylpyrrolidone, a derivative of N-vinylpyrrolidone and the like. The polyvinyl alcohol based resins can be either used alone or in combination of two kinds or more.

While no specific limitation is imposed on a polyvinyl alcohol based resin, an average degree of polymerization is from about 100 to about 3000, preferably from 500 to 3000 and a average degree of saponification is from about 85 to about 100 mol %, preferably from 90 to 100 mol % in consideration of adherence.

An acetoacetyl-containing polyvinyl alcohol based resin may also be used as the polyvinyl alcohol resin. The acetoacetyl-containing polyvinyl alcohol resin is preferred, because it can form a polyvinyl alcohol based adhesive with a highly-reactive functional group and can increase the durability of the polarizing plate.

An acetoacetyl-containing polyvinyl alcohol based resin is obtained by reacting a polyvinyl alcohol based resin and diketene to each other with a known method. Examples of known methods include: a method in which a polyvinyl alcohol based resin is dispersed into a solvent such as acetic acid, to which diketene is added and a method in which a polyvinyl alcohol based resin is previously dissolved into a solvent such as dimethylformamide or dioxane, to which diketene is added. Another example is a method in which diketene gas or diketene liquid is brought into direct contact with a polyvinyl alcohol.

No specific limitation is imposed on an acetoacetyl modification degree in an acetoacetyl-containing polyvinyl alcohol based resin or groups as far as the degree of modification is 0.1 mol % or more. If the degree of modification is less than 0.1 mol %, water resistance of an adhesive layer is insufficient, which is improper. An acetoacetyl modification degree is preferably from about 0.1 to about 40 mol %, more preferably from 1 to 20 mol %. If an acetoacetyl modification degree exceeds 40 mol %, reaction sites with a crosslinking agent is fewer to thereby reduce an effect of improvement on water resistance. An acetoacetyl modification degree is value measured with NMR.

Any of crosslinking agents that have been used in a polyvinyl alcohol based adhesive can be used as a crosslinking agent in the invention without a specific limitation thereon. A crosslinking agent that can be used is a compound having at least two functional groups having reactivity with a polyvinyl alcohol based resin. Examples thereof include: alkylene diamines having an alkylene group and two amino groups such as ethylene diamine, triethylene diamine and hexamethylene diamine; isocyanates such as tolylene diisocyanate, hydrogenated tolylene diisocyanate, trimethylolpropane tolylene diisocyanate adduct, triphenylmethane triisocyanate, methylenebis(4-phenylmethane) triisocyanate and isophorone diisocyanate, and ketoxime-blocked products thereof or isocyanates of phenol-blocked products; epoxy compounds such as ethylene glycol diglycidyl ether, polyethylene glycol diglycidyl ether, glycerin di- or triglicydyl ether, 1,6-hexanediol diglycidyl ether, trimethylolpropane triglycidyl ether, diglicidyl aniline and diglycidyl amine; monoaldehydes such as formaldehyde, acetaldehyde, propionaldehyde and butylaldehyde; dialdehydes such as glyoxal, malonaldehyde, succindialdehyde, glutardialdehyde, maleic dialdehyde and phthaldialdehyde; amino-formaldehyde resins such as condensates with formaldehyde of methylolurea, methylolmelamine, alkylated methylolurea, alkylated methylolmelamine, acetoguanamine and benzoguanamine; salts of divalent metals or trivalent metals such as sodium, potassium, magnesium, calcium, aluminum, iron and nickel, and oxides of the metals. As preferable crosslinking agent is melamine based crosslinking agent, especially preferable is a methylolmelamine.

The blending amount of the crosslinking agent is generally from about 0.1 to about 35 parts by weight, preferably from 10 to 25 parts by weight, based on 100 parts by weight of the polyvinyl alcohol based resin. In order to increase the durability, more than 30 parts by weight and not more than 46 parts by weight of the crosslinking agent may be blended based on 100 parts by weight of the polyvinyl alcohol based resin. Particularly, in the case where the acetoacetyl-containing polyvinyl alcohol resin is used, the crosslinking agent is preferably used in an amount of more than 30 parts by weight. The addition of more than 30 parts by weight and not more than 46 parts by weight of the crosslinking agent can increase the water resistance.

Note that various additives described below can be further mixed into an adhesive: coupling agents such as a silane coupling agent and a titanium coupling agent; various kinds of tackifiers; an ultraviolet absorbent; an antioxidant; stabilizers such as a heat resistance stabilizer and a hydrolysis resistance stabilizer; and the like.

The adhesive layer 2 may be formed by applying the adhesive to one or both of the copolymer resin layer (b) side of the protective film 3 and the side of the polarizer 1. After the protective film 3 and the polarize 1 are bonded together, a drying process may be performed so that the adhesive layer 2 made of the dried coating layer can be formed. After the adhesive layer 2 is formed, they may also be bonded together. The bonding between the polarize 1 and the protective film 3 may be performed using a roll laminator or the like. The heating and drying temperature and the drying time period may be appropriately determined depending on the based of the adhesive.

The thickness of the adhesive layer 2 is preferably from 0.01 to 10 μm, more preferably from 0.03 to 5 μm, because a too large post-drying thickness is not preferred in view of the adhesion between the polarize 1 and the protective film 3.

A polarizing plate of the present invention may be used in practical use as an optical film laminated with other optical layers. Although there is especially no limitation about the optical layers, one layer or two layers or more of optical layers, which may be used for formation of a liquid crystal display etc., such as a reflector, a transflective plate, a retardation plate (a half wavelength plate and a quarter wavelength plate included), and a viewing angle compensation film, may be used. Especially preferable polarizing plates are; a reflection type polarizing plate or a transflective type polarizing plate in which a reflector or a transflective reflector is further laminated onto a polarizing plate of the present invention; an elliptically polarizing plate or a circular polarizing plate in which a retardation plate is further laminated onto the polarizing plate; a wide viewing angle polarizing plate in which a viewing angle compensation film is further laminated onto the polarizing plate; or a polarizing plate in which a brightness enhancement film is further laminated onto the polarizing plate.

A reflective layer is prepared on a polarizing plate to give a reflection type polarizing plate, and this type of plate is used for a liquid crystal display in which an incident light from a view side (display side) is reflected to give a display. This type of plate does not require built-in light sources, such as a backlight, but has an advantage that a liquid crystal display may easily be made thinner. A reflection type polarizing plate may be formed using suitable methods, such as a method in which a reflective layer of metal etc. is, if required, attached to one side of a polarizing plate through a transparent protective film etc.

As an example of a reflection type polarizing plate, a plate may be mentioned on which, if required, a reflective layer is formed using a method of attaching a foil and vapor deposition film of reflective metals, such as aluminum, to one side of a matte treated protective film. Moreover, a different type of plate with a fine concavo-convex structure on the surface obtained by mixing fine particle into the above protective film, on which a reflective layer of concavo-convex structure is prepared, may be mentioned. The reflective layer that has the above fine concavo-convex structure diffuses incident light by random reflection to prevent directivity and glaring appearance, and has an advantage of controlling unevenness of light and darkness etc. Moreover, the protective film containing the fine particle has an advantage that unevenness of light and darkness may be controlled more effectively, as a result that an incident light and its reflected light that is transmitted through the film are diffused. A reflective layer with fine concavo-convex structure on the surface effected by a surface fine concavo-convex structure of a protective film may be formed by a method of attaching a metal to the surface of a transparent protective film directly using, for example, suitable methods of a vacuum evaporation method, such as a vacuum deposition method, an ion plating method, and a sputtering method, and a plating method etc.

Instead of a method in which a reflection plate is directly given to the protective film of the above polarizing plate, a reflection plate may also be used as a reflective sheet constituted by preparing a reflective layer on the suitable film for the transparent film. In addition, since a reflective layer is usually made of metal, it is desirable that the reflective side is covered with a protective film or a polarizing plate etc. when used, from a viewpoint of preventing deterioration in reflectance by oxidation, of maintaining an initial reflectance for a long period of time and of avoiding preparation of a protective layer separately etc.

In addition, a transfiective type polarizing plate may be obtained by preparing the above reflective layer as a transflective type reflective layer, such as a half-mirror etc. that reflects and transmits light. A transflective type polarizing plate is usually prepared in the backside of a liquid crystal cell and it may form a liquid crystal display unit of a type in which a picture is displayed by an incident light reflected from a view side (display side) when used in a comparatively well-lighted atmosphere. And this unit displays a picture, in a comparatively dark atmosphere, using embedded type light sources, such as a back light built in backside of a transfiective type polarizing plate. That is, the transflective type polarizing plate is useful to obtain of a liquid crystal display of the type that saves energy of light sources, such as a back light, in a well-lighted atmosphere, and can be used with a built-in light source if needed in a comparatively dark atmosphere etc.

The above polarizing plate may be used as elliptically polarizing plate or circularly polarizing plate on which the retardation plate is laminated. A description of the above elliptically polarizing plate or circularly polarizing plate will be made in the following paragraph. These polarizing plates change linearly polarized light into elliptically polarized light or circularly polarized light, elliptically polarized light or circularly polarized light into linearly polarized light or change the polarization direction of linearly polarization by a function of the retardation plate. As a retardation plate that changes circularly polarized light into linearly polarized light or linearly polarized light into circularly polarized light, what is called a quarter wavelength plate (also called λ/4 plate) is used. Usually, half-wavelength plate (also called λ/2 plate) is used, when changing the polarization direction of linearly polarized light.

Elliptically polarizing plate is effectively used to give a monochrome display without above coloring by compensating (preventing) coloring (blue or yellow color) produced by birefringence of a liquid crystal layer of a super twisted nematic (STN) type liquid crystal display. Furthermore, a polarizing plate in which three-dimensional refractive index is controlled may also preferably compensate (prevent) coloring produced when a screen of a liquid crystal display is viewed from an oblique direction. Circularly polarizing plate is effectively used, for example, when adjusting a color tone of a picture of a reflection type liquid crystal display that provides a colored picture, and it also has function of antireflection. For example, a retardation plate may be used that compensates coloring and viewing angle, etc. caused by birefringence of various wavelength plates or liquid crystal layers etc. Besides, optical characteristics, such as retardation, may be controlled using laminated layer with two or more sorts of retardation plates having suitable retardation value according to each purpose. As retardation plates, birefringence films formed by stretching films comprising suitable polymers, such as polycarbonates, polyvinyl alcohols, polystyrenes, poly methyl methacrylates, poly olefins such as polypropylene, polyarylates and polyamides; aligned films comprising liquid crystal materials, such as liquid crystal polymer; and films on which an alignment layer of a liquid crystal material is supported may be mentioned. A retardation plate may be a retardation plate that has a proper retardation according to the purposes of use, such as various kinds of wavelength plates and plates aiming at compensation of coloring by birefringence of a liquid crystal layer and of visual angle, etc., and may be a retardation plate in which two or more sorts of retardation plates is laminated so that optical properties, such as retardation, may be controlled.

The above elliptically polarizing plate and an above reflected type elliptically polarizing plate are laminated plate combining suitably a polarizing plate or a reflection type polarizing plate with a retardation plate. This type of elliptically polarizing plate etc. may be manufactured by combining a polarizing plate (reflected type) and a retardation plate, and by laminating them one by one separately in the manufacture process of a liquid crystal display. On the other hand, the polarizing plate in which lamination was beforehand carried out and was obtained as an optical film, such as an elliptically polarizing plate, is excellent in a stable quality, a workability in lamination etc., and has an advantage in improved manufacturing efficiency of a liquid crystal display.

A viewing angle compensation film is a film for extending viewing angle so that a picture may look comparatively clearly, even when it is viewed from an oblique direction not from vertical direction to a screen. As such a viewing angle compensation retardation plate, in addition, a film having birefringence property that is processed by uniaxial stretching or orthogonal biaxial stretching and a biaxial stretched film as inclined alignment film etc. may be used. As inclined alignment film, for example, a film obtained using a method in which a heat shrinking film is adhered to a polymer film, and then the combined film is heated and stretched or shrunk under a condition of being influenced by a shrinking force, or a film that is aligned in oblique direction may be mentioned. The viewing angle compensation film is suitably combined for the purpose of prevention of coloring caused by change of visible angle based on retardation by liquid crystal cell etc. and of expansion of viewing angle with good visibility.

Besides, a compensation plate in which an optical anisotropy layer consisting of an alignment layer of liquid crystal polymer, especially consisting of an inclined alignment layer of discotic liquid crystal polymer is supported with triacetyl cellulose film may preferably be used from a viewpoint of attaining a wide viewing angle with good visibility.

The polarizing plate with which a polarizing plate and a brightness enhancement film are adhered together is usually used being prepared in a backside of a liquid crystal cell. A brightness enhancement film shows a characteristic that reflects linearly polarized light with a predetermined polarization axis, or circularly polarized light with a predetermined direction, and that transmits other light, when natural light by back lights of a liquid crystal display or by reflection from a back-side etc., comes in. The polarizing plate, which is obtained by laminating a brightness enhancement film to a polarizing plate, thus does not transmit light without the predetermined polarization state and reflects it, while obtaining transmitted light with the predetermined polarization state by accepting a light from light sources, such as a backlight. This polarizing plate makes the light reflected by the brightness enhancement film further reversed through the reflective layer prepared in the backside and forces the light re-enter into the brightness enhancement film, and increases the quantity of the transmitted light through the brightness enhancement film by transmitting a part or all of the light as light with the predetermined polarization state. The polarizing plate simultaneously supplies polarized light that is difficult to be absorbed in a polarizer, and increases the quantity of the light usable for a liquid crystal picture display etc., and as a result luminosity may be improved. That is, in the case where the light enters through a polarizer from backside of a liquid crystal cell by the back light etc. without using a brightness enhancement film, most of the light, with a polarization direction different from the polarization axis of a polarizer, is absorbed by the polarizer, and does not transmit through the polarizer. This means that although influenced with the characteristics of the polarizer used, about 50 percent of light is absorbed by the polarizer, the quantity of the light usable for a liquid crystal picture display etc. decreases so much, and a resulting picture displayed becomes dark. A brightness enhancement film does not enter the light with the polarizing direction absorbed by the polarizer into the polarizer but reflects the light once by the brightness enhancement film, and further makes the light reversed through the reflective layer etc. prepared in the backside to re-enter the light into the brightness enhancement film. By this above repeated operation, only when the polarization direction of the light reflected and reversed between the both becomes to have the polarization direction which may pass a polarizer, the brightness enhancement film transmits the light to supply it to the polarizer. As a result, the light from a backlight may be efficiently used for the display of the picture of a liquid crystal display to obtain a bright screen.

A diffusion plate may also be prepared between brightness enhancement film and the above described reflective layer, etc. A polarized light reflected by the brightness enhancement film goes to the above described reflective layer etc., and the diffusion plate installed diffuses passing light uniformly and changes the light state into depolarization at the same time. That is, the diffusion plate returns polarized light to natural light state. Steps are repeated where light, in the unpolarized state, i.e., natural light state, reflects through reflective layer and the like, and again goes into brightness enhancement film through diffusion plate toward reflective layer and the like. Diffusion plate that returns polarized light to the natural light state is installed between brightness enhancement film and the above described reflective layer, and the like, in this way, and thus a uniform and bright screen may be provided while maintaining brightness of display screen, and simultaneously controlling non-uniformity of brightness of the display screen. By preparing such diffusion plate, it is considered that number of repetition times of reflection of a first incident light increases with sufficient degree to provide uniform and bright display screen conjointly with diffusion function of the diffusion plate.

The suitable films are used as the above brightness enhancement film. Namely, multilayer thin film of a dielectric substance; a laminated film that has the characteristics of transmitting a linearly polarized light with a predetermined polarizing axis, and of reflecting other light, such as the multilayer laminated film of the thin film having a different refractive-index anisotropy; an aligned film of cholesteric liquid-crystal polymer; a film that has the characteristics of reflecting a circularly polarized light with either left-handed or right-handed rotation and transmitting other light, such as a film on which the aligned cholesteric liquid crystal layer is supported; etc. may be mentioned.

Therefore, in the brightness enhancement film of a type that transmits a linearly polarized light having the above predetermined polarization axis, by arranging the polarization axis of the transmitted light and entering the light into a polarizing plate as it is, the absorption loss by the polarizing plate is controlled and the polarized light can be transmitted efficiently. On the other hand, in the brightness enhancement film of a type that transmits a circularly polarized light as a cholesteric liquid-crystal layer, the light may be entered into a polarizer as it is, but it is desirable to enter the light into a polarizer after changing the circularly polarized light to a linearly polarized light through a retardation plate, taking control an absorption loss into consideration. In addition, a circularly polarized light is convertible into a linearly polarized light using a quarter wavelength plate as the retardation plate.

A retardation plate that works as a quarter wavelength plate in a wide wavelength ranges, such as a visible-light band, is obtained by a method in which a retardation layer working as a quarter wavelength plate to a pale color light with a wavelength of 550 nm is laminated with a retardation layer having other retardation characteristics, such as a retardation layer working as a half-wavelength plate. Therefore, the retardation plate located between a polarizing plate and a brightness enhancement film may consist of one or more retardation layers.

In addition, also in a cholesteric liquid-crystal layer, a layer reflecting a circularly polarized light in a wide wavelength ranges, such as a visible-light band, may be obtained by adopting a configuration structure in which two or more layers with different reflective wavelength are laminated together. Thus a transmitted circularly polarized light in a wide wavelength range may be obtained using this type of cholesteric liquid-crystal layer.

Moreover, the polarizing plate may consist of multi-layered film of laminated layers of a polarizing plate and two of more of optical layers as the above separated type polarizing plate. Therefore, a polarizing plate may be a reflection type elliptically polarizing plate or a semi-transmission type elliptically polarizing plate, etc. in which the above reflection type polarizing plate or a transflective type polarizing plate is combined with above described retardation plate respectively.

Although an optical film with the above described optical layer laminated to the polarizing plate may be formed by a method in which laminating is separately carried out sequentially in manufacturing process of a liquid crystal display etc., an optical film in a form of being laminated beforehand has an outstanding advantage that it has excellent stability in quality and assembly workability, etc., and thus manufacturing processes ability of a liquid crystal display etc. may be raised. Proper adhesion means, such as an adhesive layer, may be used for laminating. On the occasion of adhesion of the above described polarizing plate and other optical films, the optical axis may be set as a suitable configuration angle according to the target retardation characteristics etc.

In the polarizing plate mentioned above and the optical film in which at least one layer of the polarizing plate is laminated, an adhesive layer may also be prepared for adhesion with other members, such as a liquid crystal cell etc. As pressure sensitive adhesive that forms adhesive layer is not especially limited, and, for example, acrylic based polymers; silicone based polymers; polyesters, polyurethanes, polyamides, polyethers; fluorine based and rubber based polymers may be suitably selected as a base polymer. Especially, a pressure sensitive adhesive such as acrylics based pressure sensitive adhesives may be preferably used, which is excellent in optical transparency, showing adhesion characteristics with moderate wettability, cohesiveness and adhesive property and has outstanding weather resistance, heat resistance, etc.

Moreover, an adhesive layer with low moisture absorption and excellent heat resistance is desirable. This is because those characteristics are required in order to prevent foaming and peeling-off phenomena by moisture absorption, in order to prevent decrease in optical characteristics and curvature of a liquid crystal cell caused by thermal expansion difference etc. and in order to manufacture a liquid crystal display excellent in durability with high quality.

The adhesive layer may contain additives, for example, such as natural or synthetic resins, adhesive resins, glass fibers, glass beads, metal powder, fillers comprising other inorganic powder etc., pigments, colorants and antioxidants. Moreover, it may be an adhesive layer that contains fine particle and shows optical diffusion nature.

Proper method may be carried out to attach an adhesive layer to one side or both sides of the optical film. As an example, about 10 to 40 weight % of the pressure sensitive adhesive solution in which a base polymer or its composition is dissolved or dispersed, for example, toluene or ethyl acetate or a mixed solvent of these two solvents is prepared. A method in which this solution is directly applied on a polarizing plate top or an optical film top using suitable developing methods, such as flow method and coating method, or a method in which an adhesive layer is once formed on a separator, as mentioned above, and is then transferred on a polarizing plate or an optical film may be mentioned.

An adhesive layer may also be prepared on one side or both sides of a polarizing plate or an optical film as a layer in which pressure sensitive adhesives with different composition or different kind etc. are laminated together. Moreover, when adhesive layers are prepared on both sides, adhesive layers that have different compositions, different kinds or thickness, etc. may also be used on front side and backside of a polarizing plate or an optical film. Thickness of an adhesive layer may be suitably determined depending on a purpose of usage or adhesive strength, etc., and generally is 1 to 500 μm, preferably 5 to 200 μm, and more preferably 10 to 100 μm.

A temporary separator is attached to an exposed side of an adhesive layer to prevent contamination etc., until it is practically used. Thereby, it can be prevented that foreign matter contacts adhesive layer in usual handling. As a separator, without taking the above thickness conditions into consideration, for example, suitable conventional sheet materials that is coated, if necessary, with release agents, such as silicone based, long chain alkyl based, fluorine based release agents, and molybdenum sulfide may be used. As a suitable sheet material, plastics films, rubber sheets, papers, cloths, no woven fabrics, nets, foamed sheets and metallic foils or laminated sheets thereof may be used.

In addition, in the present invention, ultraviolet absorbing property may be given to the above each layer, such as a polarizer for a polarizing plate, a transparent protective film and an optical film etc. and an adhesive layer, using a method of adding UV absorbents, such as salicylic acid ester based compounds, benzophenol based compounds, benzotriazol based compounds, cyano acrylate based compounds, and nickel complex salt based compounds.

A polarizing plate or an optical film of the present invention may be preferably used for manufacturing various equipment, such as liquid crystal display, etc. Assembling of a liquid crystal display may be carried out according to conventional methods. That is, a liquid crystal display is generally manufactured by suitably assembling several parts such as a liquid crystal cell, polarizing plates or optical films and, if necessity, lighting system, and by incorporating driving circuit. In the present invention, except that a polarizing plate or an optical film according to the present invention is used, there is especially no limitation to use any conventional methods. Also any liquid crystal cell of arbitrary type, such as TN type, and STN type, π type may be used.

Suitable liquid crystal displays, such as liquid crystal display with which the above polarizing plate or the optical film has been located at one side or both sides of the liquid crystal cell, and with which a backlight or a reflector is used for a lighting system may be manufactured. In this case, the polarizing plate or the optical film according to the present invention may be installed in one side or both sides of the liquid crystal cell. When installing the polarizing plates or the optical films in both sides, they may be of the same type or of different type. Furthermore, in assembling a liquid crystal display, suitable parts, such as diffusion plate, anti-glare layer, antireflection film, protective plate, prism array, lens array sheet, optical diffusion plate, and backlight, may be installed in suitable position in one layer or two or more layers.

Subsequently, organic electro luminescence equipment (organic EL display) will be explained. Generally, in organic EL display, a transparent electrode, an organic emitting layer and a metal electrode are laminated on a transparent substrate in an order configuring an illuminant (organic electro luminescence illuminant). Here, an organic emitting layer is a laminated material of various organic thin films, and much compositions with various combination are known, for example, a laminated material of hole injection layer comprising triphenylamine derivatives etc., a luminescence layer comprising fluorescent organic solids, such as anthracene; a laminated material of electronic injection layer comprising such a luminescence layer and perylene derivatives, etc.; laminated material of these hole injection layers, luminescence layer, and electronic injection layer etc.

An organic EL display emits light type on a principle that positive hole and electron are injected into an organic emitting layer by impressing voltage between a transparent electrode and a metal electrode, the energy produced by recombination of these positive holes and electrons excites fluorescent substance, and subsequently light is emitted when excited fluorescent substance returns to ground state. A mechanism called recombination which takes place in a intermediate process is the same as a mechanism in common diodes, and, as is expected, there is a strong non-linear relationship between electric current and luminescence strength accompanied by rectification nature to applied voltage.

In an organic EL display, in order to take out luminescence in an organic emitting layer, at least one electrode must be transparent. The transparent electrode usually formed with transparent electric conductor, such as indium tin oxide (ITO), is used as an anode. On the other hand, in order to make electronic injection easier and to increase luminescence efficiency, it is important that a substance with small work function is used for cathode, and metal electrodes, such as Mg-Ag and Al-Li, are usually used.

In organic EL display of such a configuration, an organic emitting layer is formed by a very thin film about 10 nm in thickness. For this reason, light is transmitted nearly completely through organic emitting layer as through transparent electrode. Consequently, since the light that enters, when light is not emitted, as incident light from a surface of a transparent substrate and is transmitted through a transparent electrode and an organic emitting layer and then is reflected by a metal electrode, appears in front surface side of the transparent substrate again, a display side of the organic EL display looks like mirror if viewed from outside.

In an organic EL display containing an organic electro luminescence illuminant equipped with a transparent electrode on a surface side of an organic emitting layer that emits light by impression of voltage, and at the same time equipped with a metal electrode on a back side of organic emitting layer, a retardation plate may be installed between these transparent electrodes and a polarizing plate, while preparing the polarizing plate on the surface side of the transparent electrode.

Since the retardation plate and the polarizing plate have function polarizing the light that has entered as incident light from outside and has been reflected by the metal electrode, they have an effect of making the mirror surface of metal electrode not visible from outside by the polarization action. If a retardation plate is configured with a quarter wavelength plate and the angle between the two polarization directions of the polarizing plate and the retardation plate is adjusted to π/4, the mirror surface of the metal electrode may be completely covered.

This means that only linearly polarized light component of the external light that enters as incident light into this organic EL display is transmitted with the work of polarizing plate. This linearly polarized light generally gives an elliptically polarized light by the retardation plate, and especially the retardation plate is a quarter wavelength plate, and moreover when the angle between the two polarization directions of the polarizing plate and the retardation plate is adjusted to π/4, it gives a circularly polarized light.

This circularly polarized light is transmitted through the transparent substrate, the transparent electrode and the organic thin film, and is reflected by the metal electrode, and then is transmitted through the organic thin film, the transparent electrode and the transparent substrate again, and is turned into a linearly polarized light again with the retardation plate. And since this linearly polarized light lies at right angles to the polarization direction of the polarizing plate, it cannot be transmitted through the polarizing plate. As the result, mirror surface of the metal electrode may be completely covered.

### EXAMPLES

The structure and effects of the invention are specifically described below with reference to the examples and the like.

(Moisture Permeability)

According to the JIS Z 0208 moisture permeability test (cup method), the moisture permeability is the gram weight of water vapor passing through a sample with a thickness of 0.1 mm and an area of 1 m² for 24 hours in condition of a difference of a relative humidity of 90%.

### Example 1

(Polarizer)

An 80 μm-thick polyvinyl alcohol based film was dyed in an aqueous solution of 5% by weight iodine (iodine/potassium iodide=1/10 in weight ratio). Thereafter, the film was immersed in an aqueous solution containing 3% by weight of boric acid and 2% by weight of potassium iodide, and then stretched 5.5 times in an aqueous solution containing 4% by weight of boric acid and 3% by weight of potassium iodide. Thereafter, the film was immersed in an aqueous solution of 5% by weight potassium iodide. The film was then dried in an oven at 40° C. for three minutes so that a 30 μm-thick polarizer was obtained.

(Preparation of Copolymer Resin Layer-Added Protective Film)

A cyclic olefin based resin (Topas 6013 manufactured by TICONA Company) dried at 110° C. for five hours, an adhesive resin (ADMER PF508 manufactured by Mitsui Chemicals, Inc.) and a styrene-butadiene copolymer (CLEAREN 530L manufactured by Denki Kagaku Kogyo Kabushiki Kaisha) were each supplied to each of three extruders connected to a T-shaped die and kept at 250° C., melted and kneaded, and then extruded from the T-shaped die to form a laminate of three layers in this order, which was taken up on a cooling roll while cooled with water, so that a 40 μm-thick film was obtained (the thickness ratio between the respective layers was as follows: cyclic olefin based resin: adhesive resin layer: styrene-butadiene copolymer=6:1:1). The cyclic olefin based resin had a moisture permeability of 2 g/m²/24 hours (0.1 mm in thickness, 40° C., 90%RH). The moisture permeability with respect to the 40 μm thickness was 5 g/m²/24 hours. A copolymer resin layer side of the obtained copolymer resin layer-added protective film was subjected to corona treatment.

(Adhesive)

An aqueous solution containing 100 parts by weight of an acetoacetyl-modified polyvinyl alcohol resin (13% in degree of acetylation) and 20 parts by weight of methylolmelamine was prepared so as to form an aqueous polyvinyl alcohol based adhesive solution with an adjusted concentration of 0.5% by weight.

(Preparation of Polarizing Plate)

The resin layer subjected to corona treatment of the resin layer-added protective film was bonded to one side of the polarizer with the polyvinyl alcohol based adhesive, and a 40 μm-thick saponified triacetylcellulose film (Fujitack T-40UZ (trade name) manufactured by Fuji Photo Film Co., Ltd.) was bonded to the other side of the polarizer with the polyvinyl alcohol based adhesive. In each process, the polyvinyl alcohol based adhesive was applied to the protective film side and dried at 70° C. for 10 minutes, and finally a polarizing plate was obtained. The adhesive layer was formed of the polyvinyl alcohol based adhesive so as to have a thickness of 31 nm.

### Comparative Example 1

A polarizing plate was prepared using the process of Example 1, except that a 40 μm-thick cyclic olefin based resin film (ZEONOR (trade name) manufactured by Nippon Zeon Co., Ltd.) was used after corona-treated, in place of the resin layer-added protective film. The cyclic olefin based resin film had a moisture permeability of 0.5 g/m²/24 hours.

The polarizing plate obtained in each of the example and the comparative example was evaluated as described below. The results are shown in Table 1.

<Adhesion Between Protective Film and Polarizer>

The polarizer (150 mm×100 mm) was twisted by hand, and the maximally twisted state was evaluated according to the criteria below.
∘: The polarizer and the protective film are integrated, and no peeling-off occurs.
Δ: Peeling-off is observed at end portions of the polarizer and the protective film.
×: Peeling-off is observed between the polarizer and the protective film.

<Appearance of Polarizing Plate>

The appearance of the resulting polarizing plate was evaluated. The evaluation was visually performed on the 1 m² polarizing plate according to the criteria below.
∘: There is absolutely no separated or striped portion.
×: Separated or striped portion is not observed.
The separated portion means a portion in such a state that the polarizer does not adhere to the protective film, and the striped portion means a portion where the protective film or the polarizer adheres to itself even in a very small area. The mark (−) indicates that observation was not possible due to peeling-off.

<Polarization Properties>

The degree of polarization was measured using DOT-3C manufactured by Murakami Color Research Laboratory under crossed nicols.

TABLE 1

| | | | Polarization |
|---|---|---|---|
| | Adhesion | Appearance | Degree (%) |
| Example 1 | ◯ | ◯ | 99.97 |
| Comparative Example 1 | X | — | — |

### INDUSTRIAL APPLICABILITY

The polarizing plate using the polarizer protective film of the invention itself or an optical film in which the polarizing plate is laminated is suitable for use in image displays such as liquid crystal displays, organic electro-luminescent displays and plasma display panels.

1. A polarizer protective film, comprising:
a thermoplastic resin layer having a moisture permeability of 100 g/m²/24 hours or less; and
a resin layer that comprises a copolymer containing a styrene monomer unit and is laminated on the thermoplastic resin layer through an adhesive resin layer.

2. The polarizer protective film according to claim 1, wherein the copolymer containing a styrene monomer unit is a copolymer containing a styrene monomer unit and an olefin monomer unit.

3. The polarizer protective film according to claim 1, wherein the thermoplastic resin is a cyclic olefin based resin.

4. The polarizer protective film according to claim 1, wherein the adhesive resin layer is made of a polyolefin resin modified with an unsaturated carboxylic acid or a derivative thereof.

5. The polarizer protective film according to claim 1, wherein the polarizer protective film is formed by co-extrusion.

6. The polarizer protective film according to claim 1, wherein the resin layer that comprises the copolymer containing the styrene monomer unit has a corona-treated surface.

7. A polarizing plate, comprising:
a polarizer; and
the polarizer protective film according to claim 1, wherein
the resin layer side that comprises the copolymer containing a styrene monomer unit of the polarizer protective film is laminated on at least one side of the polarizer through an adhesion layer.

8. The polarizing plate according to claim 7, wherein the adhesion layer is made of a polyvinyl alcohol based adhesive.

9. The polarizing plate according to claim 7, wherein the polarizer is a polyvinyl alcohol based polarizer.

10. An image display, comprising the polarizing plate according to claim 7.
